(19) United States
(12) Patent Application Publication
(10) Pub. No.: US 2026/0099799 A1
(43) Pub. Date: Apr. 9, 2026

(54) MULTI-SOLVER BUNDLING PLATFORM

(71) Applicant: Shipt, Inc., Birmingham, AL (US)

(72) Inventors: JIE LU, San Bruno, CA (US); ELIF TOKAR ERDEMIR, San Francisco, CA (US); ZACHARY VOLLER, Minneapolis, MN (US); BENJAMIN MOK, Minneapolis, MN (US); JOSHUA CARDOSI, Westerville, OH (US); SHANE VAUGHAN, Nashville, TN (US); SANJEEV PRAKASH, San Francisco, CA (US)

(73) Assignee: Shipt, Inc., Birmingham, AL (US)

(21) Appl. No.: 18/909,562

(22) Filed: Oct. 8, 2024

(51) Int. Cl. G06Q 10/083

(52) U.S. Cl. CPC G06Q 10/083

(57) ABSTRACT

Aspects of the present disclosure relate to an order bundling platform. In some embodiments, the order bundling platform may include a plurality of bundling systems. Executing in parallel, the plurality of bundling systems may generate bundling solutions, which may include a plurality of bundles of a plurality of orders. The order bundling platform may select a bundling solution from among bundling solutions that were generated within a maximum time.

### BACKGROUND

Computing bundles of orders may involve computational tradeoffs. For a given set of orders, a computing system may face the challenges of quickly and accurately generating bundles. A single computing technique may not sufficiently address these challenges. For instance, a first computing technique may be relatively fast but may result in suboptimal bundling. A second computing technique may generate more optimal bundles but may be relatively slow. In some instances, it may be challenging to select between different approaches.

A further challenge may be computational time constraints times faced by systems that generate bundles. These systems may be required to facilitate the completion of orders in a matter of minutes or hours, and as such, the computational time available for solvers may be severely constrained. Additionally, the computational challenges of bundling orders may increase as the number of orders to consider increases. For example, if there are hundreds or thousands of orders, one or more of which may have different characteristics, such as different order types, drop-off locations, volume, item quantity, pickup locations, delivery windows, etc., it may quickly become computationally costly to determine bundles.

### SUMMARY

In general terms, aspects of the present disclosure relate to an order bundling platform. In some embodiments, the order bundling platform may include a plurality of bundling systems. Executing in parallel, the plurality of bundling systems may generate bundling solutions, which may include a plurality of bundles of a plurality of orders. The order bundling platform may select a bundling solution from among bundling solutions that were generated within a maximum time.

In a first aspect, an order bundling platform is disclosed. The platform comprises a first bundling system; a second bundling system; a processor; and memory storing instructions that, when executed by the processor, cause the platform to: receive a bundling request, the bundling request comprising a plurality of orders; execute the first bundling system to generate a first solution, the first solution comprising a first plurality of bundles of the plurality of orders; in parallel with executing the first bundling system, execute the second bundling system to generate a second solution, the second solution comprising a second plurality of bundles of the plurality of orders; and after a maximum execution time or after receiving each of the first solution and the second solution, select the first solution or the second solution.

In a second aspect, an order processing system is disclosed. The system comprises an order bundling platform; an ordering system communicatively coupled with the order bundling platform; and a work management system communicatively coupled with the order bundling platform; wherein the order bundling platform includes a memory storing instructions that, when executed by a processor, cause the platform to: receive a bundling request, the bundling request comprising a plurality of orders received via the ordering system; execute a first bundling system to generate a first solution, the first solution comprising a first plurality of bundles of the plurality of orders; in parallel with executing the first bundling system, execute a second bundling system to generate a second solution, the second solution comprising a second plurality of bundles of the plurality of orders; and after a maximum execution time, select the first solution or the second solution.

In a third aspect, a method for bundling orders using a multi-solver bundling platform is disclosed. The method comprises receiving a bundling request, the bundling request comprising a plurality of orders; executing a first bundling system to generate a first solution, the first solution comprising a first plurality of bundles of the plurality of orders; in parallel with executing the first bundling system, executing a second bundling system to generate a second solution, the second solution comprising a second plurality of bundles of the plurality of orders; and after a maximum execution time or after receiving each of the first solution and the second solution, selecting the first solution or the second solution.

### BRIEF DESCRIPTION OF THE DRAWINGS

FIG. 1 illustrates an example network diagram in which aspects of the present disclosure may be implemented.

FIG. 2 illustrates a block diagram of an example architecture of an order bundling platform.

FIG. 3 illustrates a block diagram of an example architecture of an order bundling platform.

FIG. 4 is a flowchart of an example method according to aspects of the present disclosure.

FIG. 5 is a flowchart of an example method according to aspects of the present disclosure solution.

FIG. 6 is a flowchart of an example method according to aspects of the present disclosure.

FIG. 7 illustrates a block diagram of an example computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In example aspects, an order bundling platform is disclosed. The order bundling platform may receive a bundling request, which may include a plurality of orders. The bundling platform may output order bundles, where each bundle is a set of one or more orders. The bundling platform may include a plurality of bundling systems that generate bundling solutions from which the bundling platform may select.

In examples aspects, orders received as part of a bundle request may have some common features, such as belonging to a common region or, in some instances, being a common type of order, such as being shopping orders or delivery only orders. In some embodiments, if the number of orders is above a threshold, the platform may separate the orders into batches, such as batching 300 orders into 3 batches of 100 orders.

In example aspects, the platform may provide each batch to each bundling system of the plurality of bundling systems. In parallel, each system determines a bundling solution for a batch, where a bundling solution includes a plurality of bundles from the plurality of orders. In some embodiments, the systems may bundle the orders such that a time required to complete all of the orders in the batch is minimized. The bundling systems may use different techniques to do this. For example, a first bundling system may use a mathematical approach that finds optimal bundles, whereas a second bundling system may use a heuristic-based approach.

In example aspects, once a system generates a solution for a batch, the system provides this solution to an aggregator. In some embodiments, the bundling systems are operating under a maximum execution time. For example, the systems may only have a certain amount of time to return a bundling solution for a batch. If a system is unable to provide a solution in that time, the solution from that bundling system for the batch may not be considered by the aggregator.

In example aspects, for each batch, the aggregator may collect a solution from each solver that was able to provide a solution within the maximum execution time. From the received solutions, the aggregator may select the best solution. As an example, the best solution may be the solution having bundles with the minimum estimated time to complete the orders in the batch. If there are a plurality of batches, the aggregator may select a best solution for each batch and then combine these solutions into an aggregate bundling solution. As such, in some embodiments, the aggregator may select different systems for different batches and then aggregate the solutions from these different systems for a global solution.

Aspects of the present disclosure may provide various technical advantages. For example, parallel processing of batches and solvers may improve the overall run times of the platform. As such, the bundling platform may be used as part of a pipeline that may have strict maximum execution times. As an example, a customer may place an order, and the customer may expect to receive the order in a matter of minutes or hours. As such, to facilitate completion of the order, computation systems described herein may have to quickly process the order and assign the order to a worker. For bundling of orders to be feasible in such a pipeline, bundling computations must be fast, as well as accurate. Existing computing infrastructure and software may be insufficient. However, according to certain aspects of the present disclosure, parallel processing by different bundling systems to generate different candidate solutions for a set of orders is both a computationally fast and accurate approach, thereby providing a technical improvement over certain existing systems, which may lack adequate run-time speeds, accuracy, or both.

Yet still, in some embodiments, one bundling system may include an optimal solver that is guaranteed to find an optimal bundling solution, and a second bundling system may include a heuristic-based solver that, although not guaranteed to find an optimal solution, may have a faster run time than the optimal solver. As such, by executing these solvers on different hardware in parallel, a bundling platform may select the mathematical solution when it is calculated within a maximum execution time while also having the heuristic-based solution in case the mathematical solution takes too long to compute.

Yet still, the bundling platform may cache previous solutions from systems. By doing so, if a set of orders is received twice, the platform can select the previously generated solutions, rather than generating new solutions, a technique that results in more efficient infrastructure utilization. Yet still, the platform may flexibly add or remove bundling systems. For example, a new system, written in any programming language, can be added to the platform's group of solvers. Moreover, the platform can test new solvers on live production data without considering its solutions during the aggregation step. As such, new potential solvers can be tested on live production data to determine their impact before being implemented in production. Yet still, bundling orders can improve the efficiency of order completion. This may increase the speed at which workers are able to complete orders, improve timeliness, and decrease shipping costs.

Yet still, in an example implementation, bundling orders according to aspects of the present disclosure resulted in a reduction of time to complete orders by 5% per order while maintaining a consistent level of on-time order completion. Furthermore, optimal solvers described herein may reduce problem complexity by 95% compared to existing solutions and may provide a proof of global optimality of a bundling solution for a batch. As will be apparent, these are only some of the advantages that may be realized by aspects of the present disclosure.

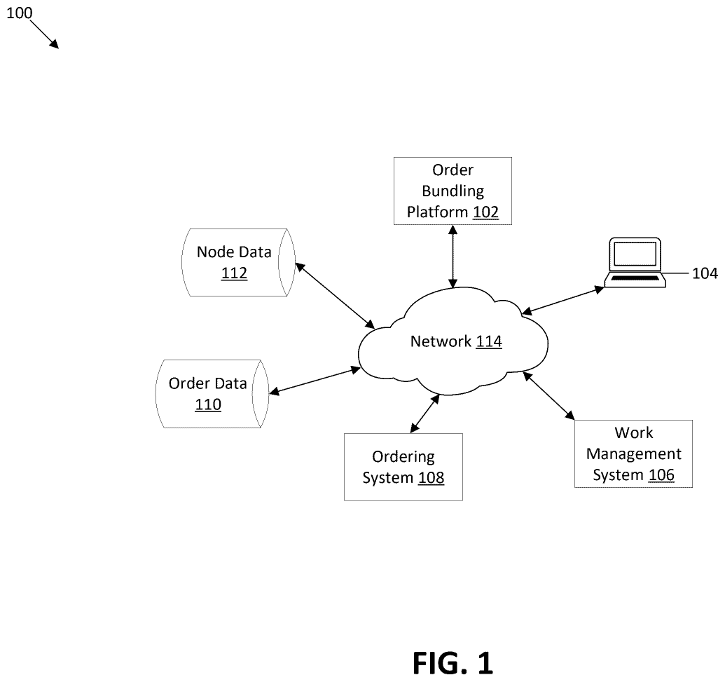

FIG. 1 illustrates a network environment 100 in which aspects of the present disclosure may be implemented. In the example shown, the environment 100 includes an order bundling platform 102, a platform administrator 104, a work management system 106, an ordering system 108, order data 110, node data 112, and network 114.

In some embodiments, one or more components of the environment 100 may be part of a common information system that includes a collection of hardware, software, and data. In some embodiments, one or more components of the environment 100 may be implemented in a common computing environment. In some embodiments, one or more components of the environment 100 may be implemented in different computing environments. One or more components of the environment 100 may be implemented in a public cloud, private cloud, hybrid cloud, or mixed cloud environment.

In some embodiments, one or more components of the environment 100 may be associated with a common entity. For example, a common entity may develop, operate, use, or otherwise be associated with one or more components of the environment 100. In some embodiments, the entity is a logistics company or a retailer.

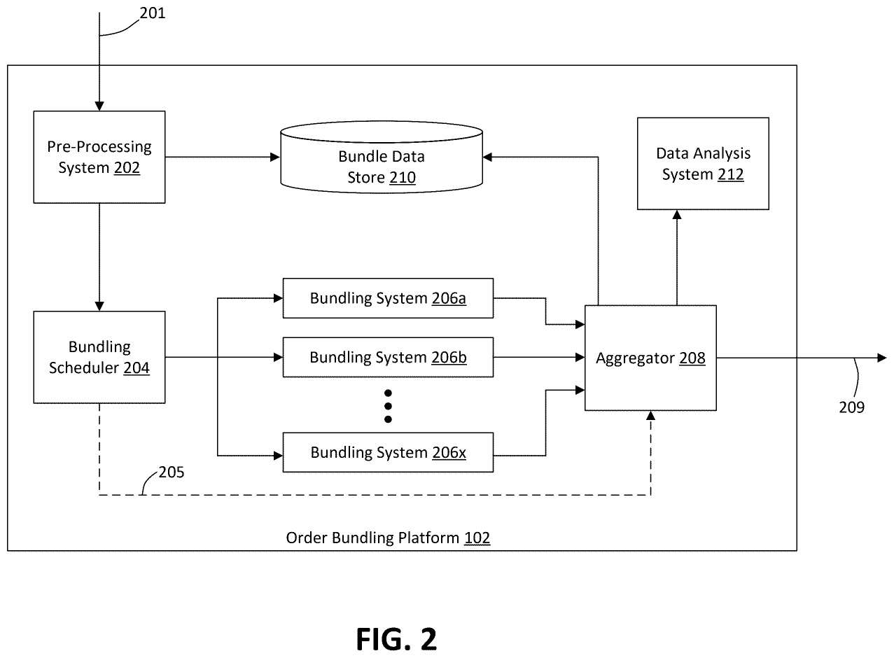

The order bundling platform 102 may include hardware and software for bundling orders. In some embodiments, the order bundling platform 102 may, among other things, receive a plurality of orders, process the orders, and output a plurality of bundles of the orders. For example, the order bundling platform 102 may receive orders from the ordering system 108, bundle the orders, and then provide the bundles to the work management system 106, which may offer the bundled orders to workers. An example architecture of the order bundling platform 102 is illustrated and described in connection with FIG. 2.

The platform administrator 104 may be an application or person that manages aspects of the order bundling platform 102. In some embodiments, the platform administrator 104 may be an engineer. The platform administrator 104 may input parameters that may be used by the order bundling platform 102. For example, the platform administrator 104 may, in some embodiments, input a maximum execution time for bundling systems of the order bundling platform 102 to generate a bundling a solution. In some embodiments, the platform administrator 104 may add a bundling system to the order bundling platform 102 or remove a bundling system from the order bundling platform.

The work management system 106 may be a computing system that facilitates completion of orders. In some embodiments, the work management system 106 may include a backend system that may be communicatively coupled with the order bundling platform 102 and may receive bundles of orders from the order bundling platform 102. In some embodiments, the order bundling platform 102 is part of the work management system 106.

In some embodiments, the work management system 106 may include a front-end system that may be used by workers to complete orders. In some embodiments, the work management system 106 facilitates the performance of additional tasks. For example, the work management system 106 may enable workers to shop for items or to perform other tasks. In some embodiments, the front-end system of the work management system 106 may include a mobile application or web application. In some embodiments, the work management system 106 may offer orders to workers to be performed via the front-end system of the work management system 106. In some instances, offering orders may include offering bundles of orders to the workers. In some instances, the workers may be gig-economy workers who use the work management system 106 to perform orders.

The ordering system 108 may be a computing system that receives orders. In some embodiments, the ordering system 108 is a digital retail system. In some embodiments, the ordering system 108 includes one or more of a delivery or shopping service via which customers may place orders for items. In some embodiments, the ordering system 108 includes a backend that is communicatively coupled with the order bundling platform 102. In some embodiments, each of the ordering system 108, the order bundling platform 102, and the work management system 106 are part of a common system. In some embodiments, the ordering system 108 includes a front-end system that may include a mobile application or web application for customers to purchase, order, or otherwise select items. In some embodiments, orders processed by the ordering system 108 may be stored in the order data 110. Example characteristics of orders are further described in connection with the order data 110.

In some embodiments, the ordering system 108 enables a selection of a completion time for an order. For example, for a given order, the ordering system 108 may receive a selection of a time by which the order is to be completed, such as same-day shipping, two-day shipping, or shipping within a next selected amount of time. As another example, for a given order, the ordering system 108 may receive a selection of a time window during which an order is to be completed. In some embodiments, the completion time received by the ordering system 108 may impact a time available to the order bundling platform 102 to generate bundling solutions. For example, if a plurality of orders must be completed within a next hour, then the order bundling platform 102 may provide a smaller max computational time for the bundling systems to generate bundles than for orders that must be completed with a next day.

In some embodiments, the environment 100 may include a plurality of distinct ordering systems 108. For example, the environment 100 may include a first ordering system 108 associated with a first entity and a second ordering system 108 associated with a second, distinct entity. For instance, the first entity may be a first retailer and the second entity may be a second retailer. In such an embodiment, the work management system 106 may be configured to facilitate orders for the plurality of retailers received from across the plurality of ordering systems. Furthermore, the order bundling platform 102 may be configured to bundle orders across the plurality of retailers received from across the plurality of ordering systems.

The order data 110 may include data associated with orders. The order data 110 may include one or more of historical or pending orders. In some embodiments, the order data 110 includes synthetic order data. The order data 110 may receive data received or generated by the ordering system 108. Furthermore, the order data 110 may include order completion data from the work management system 106 and may receive data associated with order bundles form the order bundling platform 102. Each order may include one or more items. Each order may include a source node and a destination node. The source node may be a location, such as a store, warehouse, manufacturing plant, processing facility, or other location, from which an item may be shipped. The destination node may be a location to which an item may be delivered, such a store, warehouse, drop-off node, processing facility, or other location, to which an item may be delivered. In some embodiments, the orders include items that are shipped directly from a retail store to a customer residence. In some embodiments, there may be various order types. Example order types include, but are not limited to, the following: a shopping order; a same-day delivery order; and a next-day delivery order. In some instances, a worker may use the work management system 106 to complete orders irrespective of the order type.

In some embodiments, the order data 110 may include a time required to complete an order. In the case of historical orders, this may be an actual time required to complete the order. In the case of pending or future orders, this may be a projected time. In some embodiments, the time required to complete an order may include a time required to complete the order and a time required to perform other aspects of the order, such as, for example, shop for items of an order. In some embodiments, the time required to shop for an order may be reduced if the order is bundled with another order that has a common source node. As such, the order data 110 may include a matrix of potential shopping order bundles and the respective time savings when shopping if the orders were to be bundled. In some instances, the order bundling platform 102 may use such a matrix as part of generating bundling solutions.

The node data 112 may include data associated with nodes of a supply chain. For example, the node data 112 may include data of source nodes associated with an order and destination nodes associated with an order. For a given node, the node data 112 may include one or more of the following: a node type; geographical coordinates; a region; a capacity; items available at the node; a throughput of the node; or other node data. In some embodiments, the node data 112 may include a distance matrix that identifies a distance between pairs of nodes. For example, the distance may be a distance between two retail stores, between a pickup node and a drop-off node, or between two drop-off nodes. In some embodiments, the distance is a geographical distance between two points. In some embodiments, the distance is a travel distance, such as a distance required to drive, bike, walk, or fly between the pair of nodes.

The network 114 may communicatively couple components of the network environment 100. The network 114 may be, for example, a wireless network, a wired network, a virtual network, the internet, or another type of network. Furthermore, the network 114 may include subnetworks, and the subnetworks may be different types of networks or the same type of network.

The network environment 100 may include more or fewer components than depicted in the example of FIG. 1. For example, the environment 100 may include an external system associated with a third party that is communicatively coupled with one or more components depicted in the example of FIG. 1. For example, the external system may provide software, platform, or infrastructure as a service that is used by components depicted in the example of FIG. 1.

FIG. 2 illustrates a schematic diagram of an example architecture of the order bundling platform 102. In the example shown, the order bundling platform 102 includes a pre-processing system 202, a bundling scheduler 204, bundling systems 206a-x, aggregator 208, bundle data store 210, and data analysis system 212. In some embodiments, one or more components of the bundling platform 102 may use a publish-subscribe model for exchanging data with one another. In some embodiments, one or more components of the bundling platform 102 may use a request-response-based communication model. Although example components and data exchanges are illustrated in the example of FIG. 2, the order bundling platform 102 is not limited to, and need not require, the components and example data exchanges shown in the example of FIG. 2.

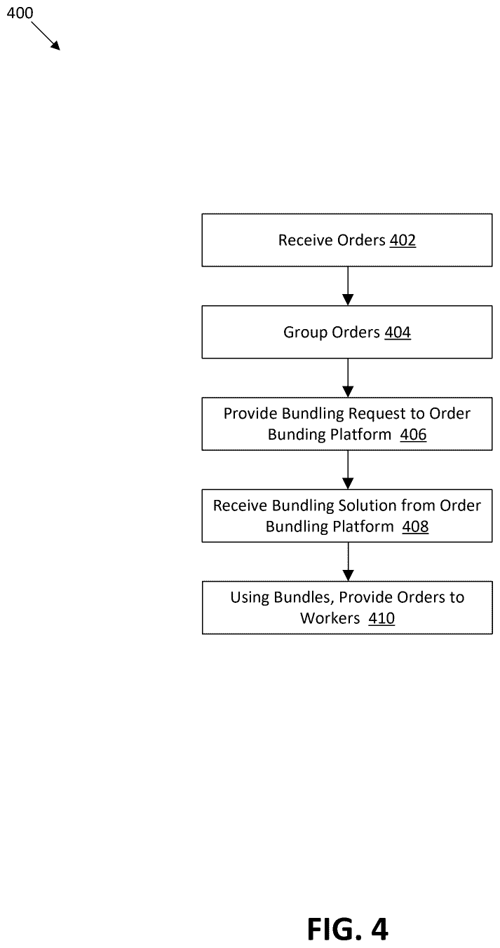

The pre-processing system 202 may, among other things, receive bundling requests and prepare orders of the bundling request to be processed by the bundling systems 206a-x. In some embodiments, the pre-processing system 202 may include an application programming interface (API) that may be called by a program communicating with the order bundling platform 102. In some embodiments, the pre-processing system 202 may receive, filter, and batch orders, example aspects of which are further described in connection with FIG. 4.

Furthermore, the pre-processing system 202 may assign IDs to batches and bundling requests, which may be used to track bundling solutions generated for batches and bundling requests. In some embodiments, the pre-processing system 202 receives the payload 201 from an external application, and the payload 201 may include one or more bundling requests. Additionally, the payload may include information that is used by one or more of the bundling systems 206a-x to generate bundling solutions. For example, the payload 201 may include one or more of a distance matrix between nodes, estimated order completion times, or other data.

The bundling scheduler 204 may determine a time to execute the bundling systems 206a-x. In some embodiments, the bundling scheduler 204, or another component, may provide batches of orders, and other data used by the bundling systems 206a-x, to the bundling systems 206a-x for bundling. In some embodiments, the bundling scheduler 204 may execute multiple instances of the same bundling scheduler. In some embodiments, the bundling scheduler 204 may provide a maximum execution time 205 to the aggregator 208. The maximum execution time 205 may be a maximum execution time that the bundling systems 206a-x have available to generate a bundling solution for a given batch or group of batches of orders.

The bundling systems 206a-x may include hardware and software for generating bundling solutions. Each bundling system of the bundling systems 206a-x may be configured to receive a batch of orders and output a bundling solution. The bundling solution may include a plurality of sets of orders that belong to the batch of orders. A set may include one or more orders and more correspond with a bundle. In some embodiments, each of the bundling systems 206a-x includes a respective bundling solver and respective hardware. The bundling solver may correspond with the software executed by the bundling systems respective hardware to generate bundling solutions. In some embodiments, the bundling solvers may be written in different programming languages and executed in different computing environments, such as computing environments with different operating systems, different memory systems, and different processor types.

In some embodiments, one or more of the bundling systems 206a-x may be configured to maximize (or minimize) an objective function when generating bundling solutions. In some embodiments, the objective function is a time required to complete a batch of orders, and one or more of the bundling systems 206a-x may generate bundles such that a time required to complete the orders is minimized. In some instances, bundling orders may reduce the overall time required to complete the batches of orders. However, bundling other orders of a batch may not reduce the overall time to complete the batches. As such, one or more of the bundling systems 206a-x may have to determine which, if any, of a plurality of orders of a batch of orders to bundle. In some embodiments, a first of the bundling systems 206a-x may seek to optimize a first objective function while a second of the bundling systems 206a-x may seek to optimize a second, different objective function.

An example solver of one of the bundling systems of the bundling systems 206a-x is an optimal solver. Such an optimal solver may use a system of equations to generate a bundling solution. For example, the optimal solver may be a constraint integer programming solver. Unlike heuristic-based solvers, for example, the optimal solver is guaranteed, in some embodiments, to find the bundles that are expected to minimize a time to complete the orders. As part of a series of equations, the optimal solver may consider, among other things, the distance between order destinations, the order time windows, the number of items for an order, and a worker's capacity.

In some embodiments, there are different implementations of the optimal solver for different use cases. For example, the optimal solver may use a first set of equations for shopping orders or on-demand completion orders and may use a second set of equations for same-day completion or next-day completion orders.

Although the optimal solver may provide optimal bundling solutions, it may, in some instances, be relatively slow when compared to solvers of other bundling systems of the bundling systems 206a-x. It may not, in every instance, return a solution for a batch within a maximum execution time. As such, in some embodiments, the order bundling platform 102 may use a bundling system with an optimal solver in parallel with faster, heuristic-based approaches to determine bundles, which are further described herein. Advantageously, in some embodiments, the aggregator 208 selects the exact solution from the bundling system with the optimal solver when possible, but when the optimal solver is unable to provide a solution prior to an expiration of a time constraint, the order bundling platform 102 may use the best available solution from one of the heuristic-based solvers.

There may be various implementations of the optimal solver depending on the embodiments. Example implementations are set forth below. Advantageously, in some embodiments, implementations of the optimal solver do not include an explicit “vehicle” variable, thereby reducing the number of constraints of the optimal solver, reducing the number of computing cycles required to determine a bundling solution, and decreasing execution times.

A first example implementation (Example 1) of an optimal solver is set forth below. Example 1 includes an objective function to be minimized and a set of ten constraints. In some embodiments, Example 1 is a capacitated single depot vehicle routing problem minimizing total completion time with respect to completion time restrictions, drive time limits, and a maximum of two stops per route. In some embodiments, minimizing total completion time includes minimizing the cumulative total of minutes required to complete the orders.

### Example 1

### Sets

C Set of drop-off nodes, wherein one node corresponds to one order
N Set of nodes, include drop-off nodes, and depot node

### Variables

xᵢⱼ Binary variable, for each arc (i, j), where i≠j, xᵢⱼ=1 means drop-off nodes i and j are bundled together and drop-off node j is visited right after drop-off node i by the same worker
sᵢ Continuous variable, the time the worker arrives at drop-off node i

### Parameters

dᵢ Demand associated with drop-off node i, such as the number of items in order associated with drop-off node i
q Capacity of vehicles, i.e. maximum number of items allowed in a bundle [aᵢ, bᵢ] Time window for drop-off node i
M Big number
cᵢⱼ Cost of arc (i, j) where i≠j
tᵢⱼ Travel time for arc (i, j) where i≠j, can include service time at drop-off node i

### Formulation:

$$min {\sum }_{i ∈ N} {\sum }_{j ∈ N , i \neq j} {c}_{ij} {x}_{ij}$$

$$s . t .$$

$${\sum }_{j ∈ N} {x}_{ij} = 1 , ∀ i ∈ C , i \neq j \qquad ( 1 )$$

$${\sum }_{i ∈ N} {x}_{ij} = 1 , ∀ j ∈ C , i \neq j \qquad ( 2 )$$

$$( {d}_{i} + {d}_{j} ) {x}_{ij} <= q , ∀ i , j ∈ C , i \neq j , {d}_{i} + {d}_{j} > q \qquad ( 3 )$$

$${\sum }_{j ∈ C} {x}_{ij} <= {x}_{0 i} , ∀ i ∈ C , i \neq j \qquad ( 4 )$$

$${\sum }_{i ∈ C} {x}_{ij} <= {x}_{0 i} , ∀ j ∈ C , i \neq j \qquad ( 5 )$$

$${s}_{i} + {t}_{ij} - M ( 1 - {x}_{ij} ) <= {s}_{j} - 1.1 min buffer , ∀ i , j ∈ C , i \neq j \qquad ( 6 )$$

$${s}_{i} + {t}_{ij} + M ( 1 - {x}_{ij} ) >= {s}_{j} - 1.1 min buffer , ∀ i , j ∈ C , i \neq j \qquad ( 7 )$$

$${a}_{i} <= {s}_{i} <= {b}_{i} , ∀ i ∈ C \qquad ( 8 )$$

$${x}_{ij} ∈ \{ 0 , 1 \} , ∀ i , j ∈ N , i \neq j \qquad ( 9 )$$

$$( {t}_{0 i} + {t}_{ij} ) {x}_{ij} <= T , ∀ i , j ∈ C , i \neq j \qquad ( 10 )$$

In Example 1, the constraint set (1) may ensure that a worker leaves a drop-off node and visits exactly one location after the drop-off node. The constraint set (2) may ensure that workers arrive at a drop-off node from exactly one location. The constraint set (3) may ensure that two nodes, and orders associated with the two nodes, cannot be bundled together if bundle capacity is exceeded. The constraint set (4)-(5) may indicate that each worker leaves a depot node and must return to a depot node. The constraint set (6) may ensure that a worker cannot arrive at drop-off node j before sᵢ+tᵢⱼ if drop-off node j is visited after drop-off node i in the same bundle. Constraint sets (7)-(9) are for variable bounds and settings, where constraint set (8) is to ensure orders will be delivered within the desired time window. Constraint set (10) may ensure that a total route length is not exceeded.

A second example implementation (Example 2) of an optimal solver is set forth below. Example 2 includes an objective function to be minimized and a set of eleven constraints. In some embodiments, Example 2 is a capacitated single depot vehicle routing problem minimizing total completion time with respect to completion time restrictions, drive time limits, and a maximum of two stops per route.

### Example 2

### Sets

C Set of drop-off nodes, one node correspond to one order
N Set of nodes, include drop-off nodes, and depot node

### Variables

xᵢⱼ Binary variable, for each arc (i, j), where i≠j, xᵢⱼ=1 means drop-off nodes i and j are bundled together and drop-off node j is visited right after drop-off node i by the same worker
sᵢ Continuous variable, the time the worker arrives at drop-off node i
fᵢ Continuous variable defining number of items that worker has in the vehicle right before arriving to drop-off node i
yᵢ Integer variable defining sequence of drop-off node i in the route

### Parameters

dᵢ Demand associated with drop-off node i, such as the number of items in order associated with drop-off node i
q Capacity of vehicles, i.e., maximum number of items allowed in a bundle [aᵢ, bᵢ] Time window for drop-off node i
cᵢⱼ Cost of arc (i, j) where i≠j
tᵢⱼ Travel time for arc (i, j) where i≠j, can include service time at drop-off node i
n Maximum number of orders in a bundle
R Maximum bundle minutes (vehicle route length in minutes)

$$min {\sum }_{i ∈ N} {\sum }_{j ∈ N , i \neq j} {c}_{ij} {x}_{ij}$$

$$s . t .$$

$${\sum }_{j ∈ N} {x}_{ij} = 1 , ∀ i ∈ C , i \neq j \qquad ( 1 )$$

$${\sum }_{i ∈ N} {x}_{ij} = 1 , ∀ j ∈ C , i \neq j \qquad ( 2 )$$

$${f}_{i} - {f}_{j} >= {d}_{i} {x}_{ij} - q ( 1 - {x}_{ij} ) , ∀ i , j ∈ C , i \neq j \qquad ( 3 )$$

$${d}_{i} <= {f}_{i} <= q , ∀ i ∈ C \qquad ( 4 )$$

$${y}_{j} >= {y}_{i} + 1 - n ( 1 - {x}_{ij} ) , ∀ i , j ∈ C , i \neq j \qquad ( 5 )$$

$$1 <= {y}_{i} <= n , ∀ i ∈ C \qquad ( 6 )$$

$${s}_{i} + {t}_{ij} - M ( 1 - {x}_{ij} ) <= {s}_{j} , ∀ i , j ∈ C , i \neq j \qquad ( 7 )$$

$${a}_{i} <= {s}_{i} <= {b}_{i} , ∀ i ∈ C \qquad ( 8 )$$

$${x}_{ij} ∈ \{ 0 , 1 \} , ∀ i , j ∈ N , i \neq j \qquad ( 9 )$$

$${u}_{j} - {u}_{i} >= {t}_{ij} {x}_{ij} - R ( 1 - {x}_{ij} ) , ∀ i ∈ N , j ∈ C , i \neq j \qquad ( 10 )$$

$$0 <= {u}_{i} <= R , ∀ i ∈ C \qquad ( 11 )$$

### Formulation:

In Example 2, the objective may be to minimize the total cost for all utilized arcs. If the cost parameter cᵢⱼ is the distance between arc (i, j), the objective may be to minimize total distance; if it is travel time between arc (i, j), then the objective may be to minimize total travel time. The constraint set (1) may ensure that workers either visit another customer or go back to the depot right after completing to a drop-off node. The constraint set (2) may ensure that workers arrive at a drop-off node from exactly one other drop-off node or from the depot. The constraint set (3) together with variable bounds (4) may ensure that bundle capacity is not exceeded. The constraint set (4)-(5) may indicate that each worker leaves and ends at a depot node. The constraint set (5) together with variable bounds (6) may ensure that no more than n orders will be included in a bundle while also ensuring no subtours will be created since each drop-off node can have a unique sequence in the route by definition of variable y. Constraints (7) may ensure that a worker cannot arrive at drop-off node j before sᵢ+tᵢⱼ if drop-off node j is visited after drop-off node i in the same bundle. Variable bounds (8) may ensure orders will be made within the desired time window of each drop-off node. Constraint set (10) and (11) may ensure the maximum route length in minutes are not violated.

A third example implementation (Example 3) of an optimal solver is set forth below. Example 3 is based on Example 2, as shown below. For example, Example 3 may comprise the variables, parameters, and constraints of Example 2, and Example 3 may have additional variables, parameters, and constraints. In some embodiments, Example 3 is a capacitated single depot vehicle routing problem minimizing total drive and shop time with respect to time window restrictions, drive time limits, and a maximum of three stops per route.

### Example 3

### Variable (in Addition to Variables of Example 2):

zᵢⱼₖ Linearized representation of xᵢⱼ*xⱼₖ. Binary variable, 1 means nodes i and j and k are in the same route and drop-off node j is visited right after i, and k is visited right after j by the same worker.

### New Parameters (in Addition to Parameters of Example 2):

### Shop Times:

ssᵢ: bundle of 1 (single) shop time in minutes for order associated with node i
sdᵢⱼ: bundle of 2 (double) shop time for orders associated with nodes i and j
stᵢⱼₖ: bundle of 3 (triple) shop times for orders associated with nodes i, j, k
Also set n−3 (max number of orders in a bundle)

### Formulation:

$$min {\sum }_{i ∈ N} {\sum }_{j ∈ C , i \neq j} {t}_{ij} {x}_{ij} + {\sum }_{i ∈ C} {ss}_{i} {z}_{0 i 0} + {\sum }_{i ∈ C} {\sum }_{j ∈ C , i \neq j} {sd}_{ij} {x}_{ij} + {\sum }_{i ∈ C} {\sum }_{j ∈ C , i \neq j} {\sum }_{k ∈ C , k \neq i , k \neq j} ( {st}_{ijk} - {sd}_{ij} - {sd}_{jk} ) {z}_{ijk}$$

$$s . t .$$

New constraints (in addition to constraints of Example 2):

$$\begin{matrix}{z}_{ijk} \leq {x}_{ij} & ∀ i , j , k ∈ C , i \neq j , j \neq k , i \neq k\end{matrix} \qquad ( 12 )$$

$$\begin{matrix}{z}_{ijk} \leq {x}_{jk} & ∀ i , j , k ∈ C , i \neq j , j \neq k , i \neq k\end{matrix} \qquad ( 13 )$$

$$\begin{matrix}{z}_{ijk} \geq {x}_{ij} + {x}_{jk} - 1 & ∀ i , j , k ∈ C , i \neq j , j \neq k , i \neq k\end{matrix} \qquad ( 14 )$$

$$\begin{matrix}{z}_{ijk} ∈ \{ 0 , 1 \} & ∀ i , j , k ∈ C , i \neq j , j \neq k , i \neq k\end{matrix} \qquad ( 15 )$$

$$\begin{matrix}{z}_{ijk} = 0 & ∀ i , j , k ∈ C , i \neq j , j \neq k , i \neq k , if {d}_{i} + {d}_{j} + {d}_{k} > q\end{matrix} \qquad ( 16 )$$

$$\begin{matrix}{z}_{0 i 0} \leq {x}_{0 i} & ∀ i ∈ C\end{matrix} \qquad ( 17 )$$

$$\begin{matrix}{z}_{0 i 0} \leq {x}_{i 0} & ∀ i ∈ C\end{matrix} \qquad ( 18 )$$

$$\begin{matrix}{z}_{0 i 0} \geq {x}_{0 i} + {x}_{i 0} - 1 & ∀ i ∈ C\end{matrix} \qquad ( 19 )$$

$$\begin{matrix}{z}_{0 i 0} ∈ \{ 0 , 1 \} & ∀ i ∈ C\end{matrix} \qquad ( 20 )$$

In Example 3, the formulation may represent a minimization of a total drive time and a total shop time. Constraint (12)-(14) may ensure that if and only if xᵢⱼ and xⱼₖ all equal 1, zᵢⱼₖ=1. Constraint (16) may fix the value to 0 if the total number of items in a bundle are greater than the max capacity. Constraint set (17)-(20) may be a special case of zᵢⱼₖ defined for the single order bundles.

Another example solver of a bundling system of the bundling systems 206a-x may be a heuristic-based solver. A heuristic-based solver may be used instead of or in addition to one or more instances of optimal solvers. A heuristic-based solver may receive a plurality of orders of a batch and bundles the orders. In some embodiments, the heuristic-based solver may apply an algorithm that bundles orders if the orders, when bundled, reduce a local time to complete the batch of orders, even if the bundled orders would not be part of a globally optimal set of bundles for the batch of orders. As such, although a heuristic-based model may have a faster run time than an implementation of the optimal solver, it may not necessarily find the optimal set of bundles for a batch of orders.

Another example solver of a bundling system of the bundling systems 206a-x may be a routing engine with a constraint programming solver. In some embodiments, the routing engine may implement a heuristic-based approach. In some embodiments, the routing engine may apply a different algorithm depending on whether bundles are being generated for orders from a single source node or across a plurality of source nodes. If the routing engine is bundling orders from a single source node, the routing engine may solve the bundling of orders as a vehicle routing with time windows problem. If the routing engine is bundling orders from across a plurality of source nodes, the routing engine may solve the bundling of orders as a vehicle routing problem with pickup and deliveries problem.

Another example solver of a bundling system of the bundling systems 206a-x may use a neighborhood search to determine bundles. As an example, the bundling systems may use an adaptive large neighborhood search (ALNS) to determine bundles. In some embodiments, the solver using ALNS may be a heuristic-based solver. In some embodiments, the solver using ALNS may generate a feasible bundling solution at each iteration of the ALNS algorithm. In some embodiments, a different version of the ALNS may be deployed depending on whether orders are being bundled from a single source node or from across a plurality of source nodes. In some embodiments, each order has a separate source node and completion node. For each store, there might be duplicate store nodes that are obtained from different orders.

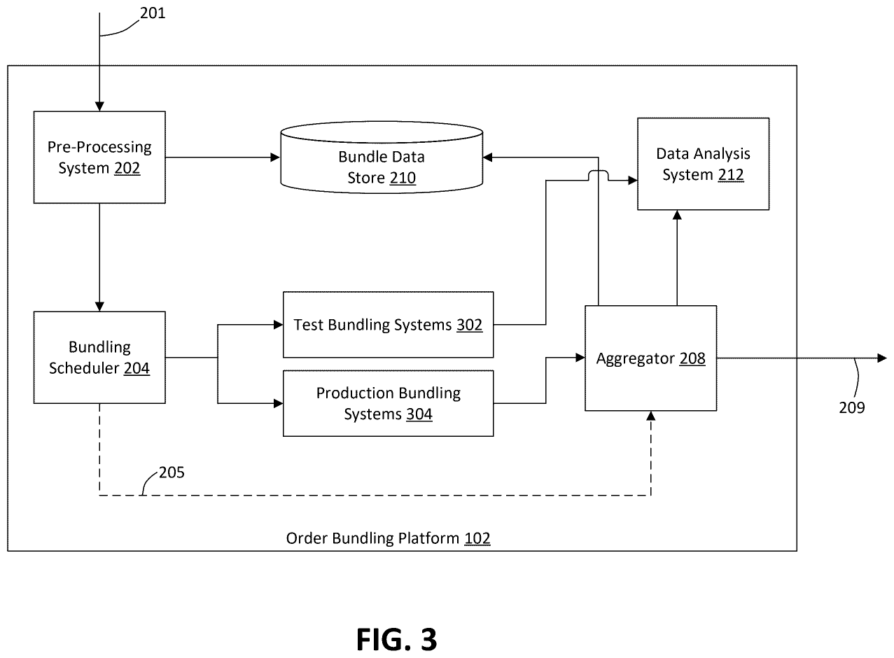

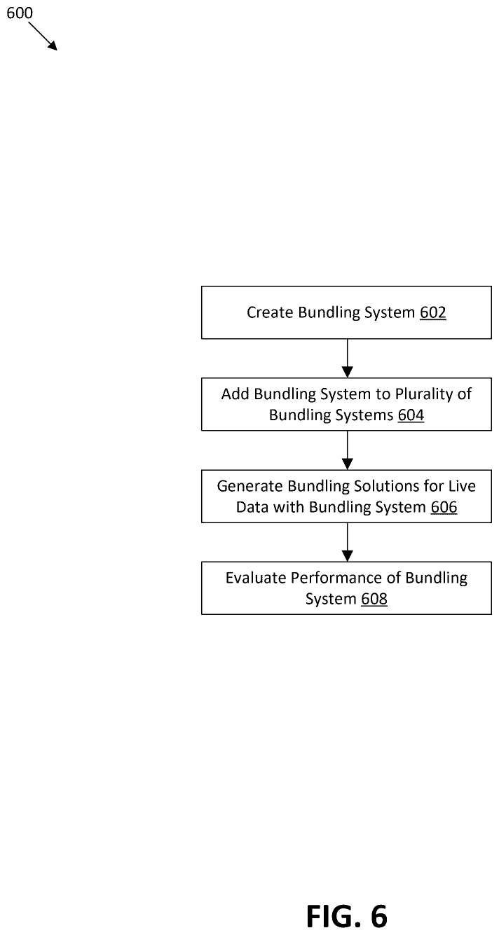

Other examples of solvers are likewise possible. For instance, the order bundling platform 102 may implement a naïve solver that outputs a bundle of one order for each bundle in a batch. As another example, order bundling platform 102 may implement a solver that is guaranteed to return a bundling solution within any maximum execution time, thereby ensuring that, even if other bundling systems, such as heuristic or optimal solvers are unable to generate a bundling solution, there will be at least one bundling solution that is available. Additionally, other implementations of an optimal solver are possible. Furthermore, other solvers that use one or more of linear programming, quadratic programming, quadratically constrained programming, mixed integer linear programming, mixed-integer quadratic programming, or mixed-integer quadratically constrained programming are likewise possible. As described in connection with FIGS. 3 and 6, new bundling systems with new solvers may be tested and added by the order bundling platform 102.

In some embodiments, bundling solvers of the bundling systems 206a-x may differ from one another regarding generation of cross-source node bundles. For example, a first solver may only consider bundling orders if the orders' source nodes are the same node. A second solver, however, may consider bundling orders that may have different source nodes. In some embodiments, because a heuristic-based solver may have a relatively fast execution time when compared to an optimal solver, the heuristic-based solver may be able to consider bundling orders across source nodes while still generating a bundling solution within a maximum execution time, whereas an optimal solver may not be able to consider cross-source node bundles, as it may create a sufficiently high likelihood that the optimal solver may not generate a bundling solution within a maximum execution time. Therefore, due to an ability to consider cross-source node bundles, a heuristic solver, or another solver that considers cross-source node bundles, may be able to generate bundling solutions that cannot be generated by other solvers, such as, in some instances, optimal solvers.

The aggregator 208 may be an application that receives bundling solutions from the bundling systems 206a-x. For example, the aggregator 208 may receive a bundling solution from each instance of each bundling system of the bundling systems 206a-x. Furthermore, the aggregator 208 may receive a maximum execution time for the bundling systems 206a-x to generate bundling solutions, such as the maximum execution time 205 received from the bundling scheduler 204. Among other things, the aggregator 208 may, for a batch, select a bundling solution from among a plurality of bundling solutions, combine bundling solutions for a plurality of batches to generate an aggregate solution for a plurality of orders received by the order bundling platform 102, and output bundling solutions. Example aspects of operations that may be performed by the aggregator 208 are further described in connection with FIG. 4.

The bundle data store 210 may store data corresponding to orders received by the order bundling platform 102 and bundles generated by the order bundling platform 102. In some embodiments, the bundle data store 210 may receive data generated or received by the pre-processing system 202 or the aggregator 208.

The data analysis system 212 may include a data storage and analytics system for analyzing data generated by the order bundling platform 102. For example, the data analysis system 212 may analyze data generated by the bundling systems 206a-x. In some embodiments, the data analysis system 212 is a cloud-based data analytics platform. In some embodiments, the data analysis system 212 may perform one or more of the following: evaluate run times of solvers of the bundling systems 206a-x; evaluate which bundling solutions are selected by the aggregator 208; evaluate the accuracy or projected completion times of bundling solutions; and perform other analytics tasks.

In the example of FIG. 2, the order bundling platform 102 may output a bundling solution 209 to a downstream system. The bundling solution 209 may be a bundling solution selected by the aggregator 208 from the bundling solutions output by the bundling systems 206a-x, or an aggregation of bundling solutions output by the bundling systems 206a-x. For example, the bundling platform 102 may provide the bundling solution 209 to the work management system 106, which may provide the bundles of orders to workers.

FIG. 3 illustrates an example architecture of the order bundling platform 102. The example architecture of the order bundling platform 102 may include components analogous to those illustrated and described in connection with FIG. 2. Furthermore, in the example of FIG. 3, the order bundling platform 102 includes test bundling systems 302 and production bundling systems 304. The test bundling systems 302 may include one or more bundling systems. The production bundling systems 304 may include one or more bundling systems. Each bundling system of the test bundling systems 302 and the production bundling systems 304 may include, among other things, hardware and a bundling solver. In the example of FIG. 2, the bundling systems 206a-x are described as production bundling systems 304. However, the order bundling platform 102 may be configured such that one or more of the bundling systems 206a-x are test bundling systems 302. In some embodiments, the platform administrator 104 may move a given bundling systems from the test bundling systems 302 to the production bundling systems 304, or vice-versa.

In some embodiments, a difference between the test bundling systems 302 and the production bundling systems 304 may be that, whereas solutions generated by the production bundling systems 304 may be provided to the aggregator 208 for potential selection, solutions generated by the test bundling systems 302 may not be provided to the aggregator 208. As a result, the aggregator 208 may not select from solutions generated by the test bundling system 302. Therefore, although the test bundling systems 302 may receive live order data and generate bundling solutions, the output of the test bundling systems 302 may not ultimately impact the solutions generated by the order bundling platform 102. Advantageously, this enables testing of the test bundling systems 302 in a production environment without having the output of the test bundling systems 302 impact a quality of production until it is determined that the test bundling systems 302 are to be added to the production bundling systems 304. Example aspects of testing a bundling system is further described in connection with FIG. 6.

FIG. 4 is a flowchart of an example method 400 in which bundling is used as part of processing orders. In some embodiments, components of the environment 100 may be used to perform operations of the method 400.

In the example shown, the ordering system 108 may receive orders (step 402). For example, the ordering system 108 may receive, from a customer, a selection of an order type, one or more items, a source node, a destination node, a completion method, a completion time, and other options associated with placing an order. In some embodiments, the ordering system 108 may continually receive orders. In some embodiments, the ordering system 108 may itself generate orders, such as when the ordering system 108 is configured to generate item orders based on a schedule.

In the example shown, the ordering system 108 may group orders (step 404). For example, the ordering system 108 may group orders based in part on how the orders are to be performed. In some embodiments, the ordering system 108 may group orders based on one or more of the following characteristics: an order type; an entity associated with a source node, such as a retailer that is providing the items to the customer; a geographical region of a source node or destination node of an order; a time, such as a day or time window that the order is to be completed; or another order characteristic. By grouping orders, the ordering system 108 may generate groups of orders that are to be provided to the order bundling platform 102 for bundling. As an example of grouping orders, the ordering system 108 may receive one thousand orders. The ordering system 108 may, from the one thousand orders, determine a group of orders that are associated with Retailer X, that are in geographical region Y, and that are scheduled to be performed on the same day. This group of orders may then be provided to the order bundling platform 102 for the order bundling platform 102 to generate efficient bundles of these orders to provide to workers located in geographical region Y to fulfill the orders on the given day.

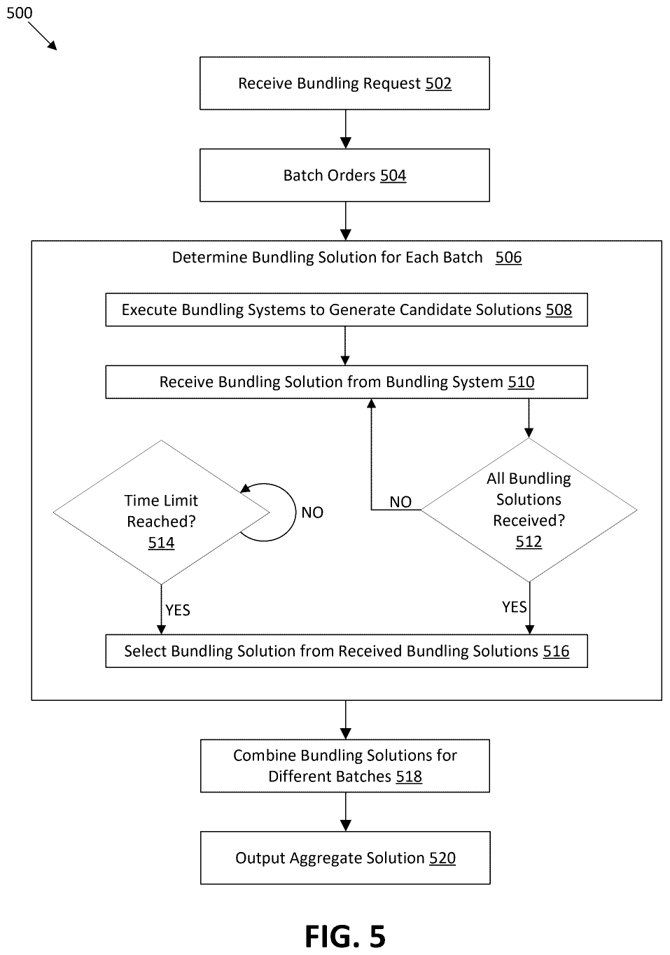

In the example shown, the ordering system 108 may provide a bundling request to the order bundling platform 102 (step 406). In some embodiments, the ordering system 108 may provide a plurality of bundling requests to the order bundling platform 102. The bundling request may include a plurality of orders, which may correspond to a group of orders determined by the ordering system 108 during the step 404. Additionally, the bundling request may include additional data that is used by the order bundling platform 102 to generate bundles. In response to receiving the bundling request, the order bundling platform 102 may generate a bundling solution, as described, for example, in connection with FIGS. 2 and 5.

In the example shown, the work management system 106 may receive a bundling solution from the order bundling platform 102 (step 408). The bundling solution may include a plurality of bundles for the group of orders provided to the order bundling platform 102 at the step 406.

In the example shown, the work management system 106 may use the bundles received from the order bundling platform 102 as part of providing orders to workers (step 410). For example, the work management system 106 may offer a bundle of orders to a worker to perform. The work management system 106 may offer a bundle of orders to a worker instead of or in addition to providing single orders to the worker to perform. In some embodiments, the work management system 106 may offer a bundle of orders to workers, and if the bundle of orders is not accepted by any worker, then the work management system 106 may offer individual orders of the bundle to workers.

In some embodiments, the work management system 106 may provide metrics associated with bundle acceptance and bundle order performance to the order bundling platform 102, and in response, the order bundling platform 102 may adjust how the bundling systems 206a-x generate bundles. For instance, if bundles having a particular characteristic, such as including orders with a certain characteristic (such as having a particular source node, source retailer, destination region, order type, item, etc.), are associated with late completion times or are associated with workers rejecting the bundle, then for subsequent bundle requests, the bundling systems may be weighted to avoid the characteristics associated with late completion times or rejected bundles, thereby providing a feedback loop between the work management system 106 and the order bundling platform 102. As an example, it may be determined that bundles of orders associated with certain order time and a certain source node are associated with late complete times, and as such, the bundling systems may be weighted so as to avoid generating bundles with that order type and source node.

FIG. 5 is a flowchart of an example method 500 for generating bundles. In some embodiments, aspects of the method 500 may be performed by the order bundling platform 102 using one or more components described in connection with FIG. 2.

In the example shown, the order bundling platform 102 may receive a bundling request (step 502). The bundling request may include a plurality of orders and data corresponding to the plurality of orders, such as order data described in connection with the order data 110 and node data 112 of FIG. 1. In some embodiments, the bundling request may also include additional data. For example, the bundling request may include one or more of the following: a maximum execution time, such as a time by which a bundling solution must be output by the order bundling platform 102; data from the node data 112, such as travel distances between nodes; data associated with performing orders, such as an estimated completion time, which may include an estimated shopping and/or delivery time, and an efficiency gained by bundling two orders, such as a time saved by bundling two orders; an identification of which bundling systems of the bundling systems 206a-x are to be used; an identification of the work management system 106 to which a bundling solution is to be output; metadata associated with the plurality of orders provided to the order bundling platform; or other data.

In some embodiments, the order bundling platform 102 receives a bundling request for a plurality of orders an amount of time prior to a completion time of the orders of the bundling request. For example, the bundling request may be received at least four hours, eight hours, twelve hours, one day, or another amount of time prior to the completion time of the orders. As such, the order bundling platform 102 may have sufficient time to generate bundles, the work management system 106 may have sufficient time to provide order bundles to workers, and the workers may have sufficient time to perform the orders prior to the completion time of the orders, but only if the order bundling platform can efficiently generate bundling solutions.

In the example shown, the order bundling platform 102 may batch orders (step 504). For example, the order bundling platform 102 may group the plurality of orders of the bundling request into subgroups, which may be batches. In some embodiments, the batches of orders are equal-sized subgroups of the plurality of orders. For example, if the bundling request includes 1200 orders, then the order bundling platform 102 may batch the plurality of orders into four batches of 300 orders. In some embodiments, the order bundling platform 102 may generate batches based at least in part on characteristics of orders of the plurality of orders, such as by batching together orders that share a common characteristic. In some embodiments, each batch is assigned an ID, such as an alphanumeric string.

In some embodiments, batch sizes are determined based on features of the bundling systems 206a-x. For example, greater batch sizes may enable more potential bundling combinations, which may result in more efficient order combinations and faster order completion times. However, generating bundling solutions for greater batch sizes may require faster execution times. Therefore, in some embodiments, batch sizes may be selected such that they are as large as possible and also such that it is expected that the bundling systems 206a-x to which they are provided are sufficiently likely to generate a bundling solution. As such, in some embodiments, the faster the expected execution times of the bundling systems 206a-x, the greater the batch sizes, and the slower the expected execution times of the bundling systems 206a-x, the smaller the batch sizes.

As an example, for a heuristic-based bundling system, the order bundling platform 102 may not generate any batches or may generate fewer batches that are generated for a bundling system with an optimal solver. For example, the heuristic-based solver may be configured to generate a bundling solution within a maximum execution time for a greater number orders at a time than an optimal solver, thereby enabling the order bundling platform 102 to provide a greater number of orders to the heuristic-based solver, which may, in some instances, enable the heuristic-based solver to identify batches that could not be identified by an optimal solver.

In the example shown, the order bundling platform 102 may determine a bundling solution for each batch (step 506). Although described in the context of being performed for a particular batch, aspects of the step 506 may be performed for each batch of the plurality of batches generated at the step 504. In some embodiments, aspects of the step 506 may be performed in parallel for each batch of the plurality of batches.

In the example shown, the order bundling platform 102 may execute the bundling systems 206a-x to generate candidate solutions for the batch (step 508). For example, the order bundling platform 102 may provide the plurality of orders of the batch to an instance of each of the bundling systems 206a-x and execute the bundling systems 206a-x in parallel. Moreover, for other batches, the order bundling platform 102 may do the same, providing the other batches to other instances of each of the bundling systems 206a-x. As such, the order bundling platform 102 may process batches in parallel and may also execute different bundling systems 206a-x in parallel to generate candidate solutions for a given batch. Advantageously, this dual-layer parallel processing may increase the execution time of the order bundling platform 102, maintain bundling accuracy, and enable more computations to be performed within a maximum time. Further aspects of example bundling systems 206a-x are described in connection with FIG. 2.

In the example shown, the order bundling platform 102 may receive a bundling solution from a bundling system (step 510). For example, the aggregator 208 may receive a bundling solution from a bundling system of the bundling systems 206a-x. In some embodiments, the bundling systems 206a-x may provide bundling solutions to the aggregator 208 once the bundling systems 206a-x have finished executing. As such, because different bundling systems 206a-x may have different execution times, the aggregator 208 may receive different bundling solutions at different times.

In the example shown, the order bundling platform 102 may determine whether the aggregator 208 received all of the bundling solutions (step 512). For example, the aggregator 208 may determine whether it has received a bundling solution from each bundling system of the plurality of bundling systems 206a-x. If so (e.g., taking the “YES” branch), the order bundling platform 102 may proceed to the step 516. If the aggregator 208 determines that it has not yet received a bundling solution from each bundling system of the plurality of bundling systems 206a-x (e.g., taking the “NO” branch), the order bundling platform 102 may return to the step 510.

In the example shown, there may be maximum execution time for determining bundling solutions, as illustrated by the step 514, which may be implemented as a timer at the aggregator 208 or another component of the order bundling platform 102. The maximum execution time may be associated with a maximum execution time of the bundling systems 206a-x. If a given bundling system of the bundling systems 206a-x does not output a bundling solution for a given batch before the maximum execution time, then the aggregator 208 may not consider a bundling solution from the given bundling system for that batch. In some embodiments, once the maximum execution time is reached, the order bundling platform 102 may stop execution of any bundling systems that have not yet generated a bundling solution, thereby saving computational resources. In some embodiments, if a bundling system has not yet returned a solution by the maximum execution time, then it may continue to execute to generate a bundling solution for analytics or caching purposes, but its solution may not be considered by the aggregator 208 for that batch.

In some embodiments, the maximum execution time is set by the platform administrator 104. In some embodiments, the maximum execution time is determined at least in part on a deadline or required completion time of the plurality of orders. For example, the order bundling platform 102 may be required to output a bundling solution a sufficient amount of time prior to the completion time of orders of the batch, so that the work management system 106 can facilitate completion of the items prior to the completion time. In an example embodiment, the maximum execution time is between two to four minutes, and as such, the bundling systems 206a-x must generate bundling solutions in less than two to four minutes. Other values for time limits are likewise possible.

In response to determining that the time limit has been reached (e.g., taking the “YES” branch), order bundling platform 102 may proceed to step 516, even if the order bundling platform 102 has not yet received a bundling solution from each of the bundling systems 206a-x. If the time limit has not yet been reached (e.g., taking the “NO” branch), the order bundling platform 102 may not continue to the step 516 and instead may wait until the time limit is reached.

In the example shown, the order bundling platform 102 may select a bundling solution from among the bundling solutions received from the bundling systems 206a-x for the batch (step 516). In some embodiments, the aggregator 208 may select a bundling solution that is expected to minimize or maximize an objective function. As an example, the objective function may be an estimated time required to complete each order of the batch, and the aggregator 208 may select the bundling solution that has the smallest expected time to complete the plurality of orders of the batch. In other embodiments, the aggregator 208 may select a bundling solution based on a combination of metrics, such as one or more of a distance travelled, a time, a cost, a likelihood of on-time order completion, or other metrics. In some embodiments, different metrics may be converted into a common metric, such as time. For example, a travel distance or cost can be converted into a time metric. In some embodiments, the aggregator 208 may select a bundling solution from an optimal solver if it is available (e.g., if the optimal solver generated a bundling solution within the maximum execution time), and if it is not available, then the aggregator 208 may select a solution from a heuristic-based solver.

In some instances, the aggregator 208 may select bundling solutions from different bundling systems of the bundling systems 206a-x for different batches. For example, for a first batch, the aggregator 208 may select a bundling solution generated by an implementation of an optimal solver, example aspects of which are described above in connection with FIG. 2. However, for a second batch, which may have been generated from a same bundling request, the aggregator 208 may select a bundling solution from a heuristic-based solver. Advantageously, therefore, aspects of the present disclosure enable a flexible selection of which solver is used on a batch-by-batch basis, thereby enabling use of potentially more accurate solutions from optimal solvers when the optimal solvers are able to generate a solution within a maximum execution time, while also enabling use of a faster, fallback heuristic solver for a batch for which an optimal solver may not be able to generate a bundling solution within a maximum execution time.

As illustrated by the example of FIG. 5, there may be at least two scenarios in which the order bundling platform 102 proceeds to select a bundling solution from the bundling solutions generated by the bundling systems 206a-x for a given batch. In one scenario, the order bundling platform 102 may determine that each bundling systems of the bundling systems 206a-x has generated a bundling solution. In another scenario, the order bundling platform 102 may determine that a time limit has been reached.

Additionally, the order bundling platform 102 may, in some instances, retrieve a bundling solution for a given batch from a storage system, such as a cache. For example, a bundling solution for a plurality of orders may have already been generated at prior time by using aspects of the steps 508-516 and then cached. If the orders were not completed, then the order bundling platform 102 may receive a bundling request that includes the plurality of orders. Based on an ID of the plurality of orders or a batch of the plurality of orders, the order bundling platform 102 may retrieve the stored bundling solution instead of reperforming the steps 508-516, and as such, the speed at which bundling is performed may be increased and computing times reduced. For example, in an example implementation, caching previous bundling solutions resulted in a 30% reduction of executions of bundling solvers.

In the example shown, the order bundling platform 102 may combine bundling solutions for different batches (step 518). In some embodiments, combining bundling solutions for different batches results in an aggregate bundling solution. In some embodiments, this combination may include concatenating the bundling solutions selected for different batches. Combining the bundling solutions may result in a plurality of bundles of one or more orders, wherein each order of the plurality of orders of the bundling request belongs to a bundle of the plurality of bundles.

In the example shown, the order bundling platform 102 may output an aggregate bundling solution (step 520). For example, the order bundling platform 102 may output the aggregate bundling solution to the work management system 106. Additionally, the order bundling platform 102 may output the aggregate bundling solutions, and the individual solutions for the batches, to the data analysis system 212.

FIG. 6 is a flowchart of an example method 600 for testing a bundling system of the order bundling platform 102.

In the example shown, a bundling system may be created (step 602). In some embodiments, the platform administrator 104 may create a bundling system. In some embodiments, creating a bundling system may include creating a bundling solver and configuring a computing environment to execute the bundling solver. In some embodiments, the bundling solver may be written in any programming language, and as such, irrespective of the language in which it is written, it may be tested and added to the order bundling platform 102. In some embodiments, the bundling solver may be derived from an existing bundling solver. In some embodiments, the bundling solver may be received from a third-party entity.

In the example shown, the order bundling platform 102 may add the bundling system to the plurality of bundling systems of the order bundling platform 102 (step 604). In some embodiments, the bundling systems 102 may be added to the test bundling systems 302, which are further described in connection with FIG. 3.

In the example shown, the order bundling platform 102 may generate bundling solutions for live data with the added bundling system (step 606). For example, as a test bundling system, the added bundling system may receive live order data. That is, the bundling system may receive the same plurality of orders of the bundling request, and other data that may be used to generate bundles, as the production bundling systems 304. Moreover, similar to the production bundling systems 304, the added bundling system may generate bundling solutions in real time and may be subject to the same maximum execution time as the production bundling systems 304. Moreover, similar to the bundling systems 206a-x, the added bundling system may be executed in parallel with the bundling systems of the order bundling platform 102. However, as described in connection with FIG. 3, solutions generated by the added bundling system may not be provided to the aggregator 208 for potential selection as the bundling solution for a batch.

In the example shown, the order bundling platform 102 may evaluate a performance of the added order bundling system (step 608). In some embodiments, the data analysis system 212 may be used to evaluate a performance of the added order bundling system. In some embodiments, evaluating a performance of the added order bundling system includes determining metrics associated with bundling solutions generated by the added order bundling system, such as a time, cost, distance, or other metric. In some embodiments, evaluating the performance comprises determining an execution time of the added order bundling system. In some embodiments, the order bundling platform 102 may add the bundling system to the production bundling systems 304 depending on a performance of the bundling system. For example, if the bundling system generates a bundling solution for a batch with an expected completion time below a threshold, and if the bundling solver generates the bundling solution within the maximum execution time, then the bundling system may be added to the production bundling systems 304. In some embodiments, the order bundling platform 102 may compare performance of the added order bundling system to performance of existing order bundling systems and the swap the new order bundling system with an existing order bundling system if the new order bundling system has a faster execution time or generates more accurate bundles (e.g., bundles associated with a shorter completion time for the bundled orders) than the existing order bundling system.

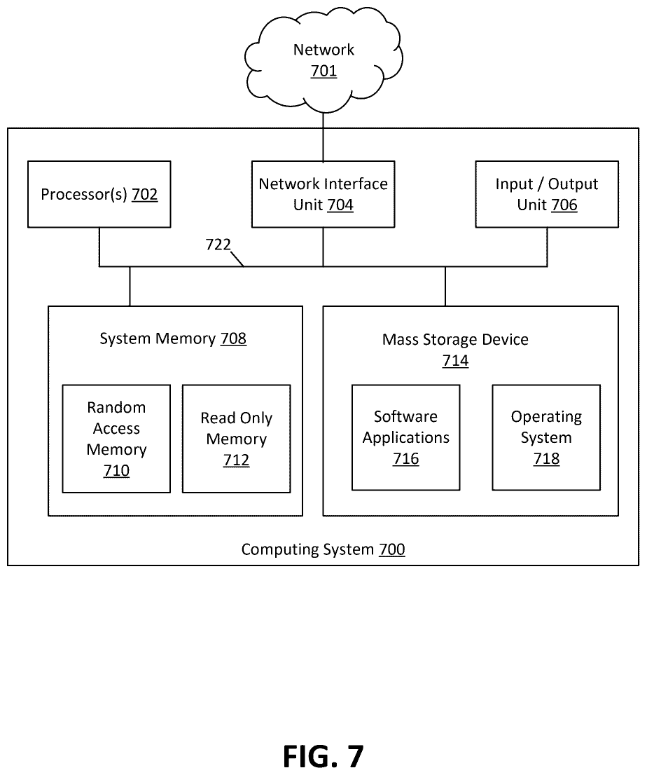

FIG. 7 illustrates an example block diagram of a virtual or physical computing system 700. One or more aspects of the computing system 700 can be used to implement the system and processes described herein. For example, one or more of the components of FIG. 1, or subcomponents thereof, may be implemented using aspects of the computing system 700.

In the embodiment shown, the computing system 700 includes one or more processors 702, a system memory 708, and a system bus 722 that couples the system memory 708 to the one or more processors 702. The system memory 708 includes RAM (Random Access Memory) 710 and ROM (Read-Only Memory) 712. A basic input/output system that contains the basic routines that help to transfer information between elements within the computing system 700, such as during startup, is stored in the ROM 712. The computing system 700 further includes a mass storage device 714. The mass storage device 714 is able to store software instructions and data. The one or more processors 702 can be one or more central processing units or other processors.

The mass storage device 714 is connected to the one or more processors 702 through a mass storage controller (not shown) connected to the system bus 722. The mass storage device 714 and its associated computer-readable data storage media provide non-volatile, non-transitory storage for the computing system 700. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 700.

According to various embodiments of the invention, the computing system 700 may operate in a networked environment using logical connections to remote network devices through the network 701. The network 701 is a computer network, such as an enterprise intranet and/or the Internet. The network 701 can include a LAN, a Wide Area Network (WAN), the internet, wireless transmission mediums, wired transmission mediums, other networks, and combinations thereof. The computing system 700 may connect to the network 701 through a network interface unit 704 connected to the system bus 722. It should be appreciated that the network interface unit 704 may also be utilized to connect to other types of networks and remote computing systems. The computing system 700 also includes an input/output controller 706 for receiving and processing input from a number of other devices, including a touch user interface display screen, or another type of input device. Similarly, the input/output controller 706 may provide output to a touch user interface display screen or other type of output device.

As mentioned briefly above, the mass storage device 714 and the RAM 710 of the computing system 700 can store software instructions and data. The software instructions include an operating system 718 suitable for controlling the operation of the computing system 700. The mass storage device 714 and/or the RAM 710 also store software instructions that when executed by the one or more processors 702, cause one or more of the systems, devices, or components described herein to provide functionality described herein. For example, the mass storage device 714 and/or the RAM 710 can store software instructions that, when executed by the one or more processors 702, cause the computing system 700 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, two or more operations can be performed as a single operation, additional operations can be performed, and disclosed operations can be excluded without departing from the present disclosure. Further, certain operation can be accomplished via one or more sub-operations. The disclosed methods and processes, or aspects of the disclosed methods and processes, can be repeated. Moreover, although certain operations are described as being performed by certain components, other components may perform such operations, depending on the embodiment, as will be understood by those having ordinary skill in the art.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A platform, the platform comprising:
a first bundling system configured to generate a first solution, wherein the first bundling system comprises first hardware and a first solver;
a second bundling system configured to generate a second solution, wherein the second bundling system comprises second hardware and a second solver, wherein the second solver has a faster execution time than the first solver;
a third bundling system configured to generate a third solution, wherein the third bundling system comprises third hardware and a third solver, wherein the third solver is written in a different programming language from a programming language of the first solver and the second solver:
a bundling scheduler configured to determine a maximum execution time based on a bundling request;
a processor; and
memory storing instructions that, when executed by the processor, cause the platform to:
receive the bundling request, the bundling request comprising a plurality of orders;
determine, by the bundling scheduler, the maximum execution time based on the bundling request;
execute the first bundling system to generate the first solution, the first solution comprising a first plurality of bundles of the plurality of orders;
in parallel with executing the first bundling system, execute the second bundling system to generate the second solution, the second solution comprising a second plurality of bundles of the plurality of orders;
in parallel with executing the first bundling system and the second bundling system, execute the third bundling system to generate the third solution, the third solution comprising a third plurality of bundles of the plurality of orders; and
after the maximum execution time:
determine that that first bundling system failed to generate the first solution within the maximum execution time;
in response to determining that the first bundling system failed to generate the first solution within the maximum execution time, stop execution of the first bundling system; and
by an aggregator, select the second solution or the third solution, wherein selecting the second solution or the third solution comprises selecting the solution having the smallest estimated time to complete.

2. (canceled)

3. (canceled)

4. (canceled)

5. (canceled)

6. (canceled)

7. The platform of claim 1, wherein the instructions, when executed by the processor, further cause the platform to provide the selected second solution or the selected third solution to a work management system to provide bundles of orders to workers.

8. (canceled)

9. The platform of claim 1,
wherein the first bundling system includes an optimal solver; and
wherein the second bundling system includes a heuristic solver.

10. The platform of claim 1, wherein each order of the plurality of orders comprises one or more items, a source node, and a destination node.

11. The platform of claim 1, wherein the instructions, when executed by the processor, further cause the platform to, prior to executing the first bundling system and prior to executing the second bundling system, separate the plurality of orders into a plurality of batches.

12. The platform of claim 11,
wherein executing the first bundling system to generate the first solution comprises executing, in parallel, a plurality of instances of the first bundling system to generate first bundling solutions for the plurality of batches; and
wherein executing the second bundling system to generate the second solution comprises executing, in parallel, a plurality of instances of the second bundling system to generate second bundling solutions for the plurality of batches.

13. The platform of claim 1,
wherein the first solution includes bundles of orders having different source nodes; and
wherein the second solution does not include any bundles with orders having different source nodes.

14. An order processing system, the order processing system comprising:
an order bundling platform;
an ordering system communicatively coupled with the order bundling platform; and
a work management system communicatively coupled with the order bundling platform;
wherein the order bundling platform includes a memory storing instructions that, when executed by a processor, cause the platform to:
receive a bundling request, the bundling request comprising a plurality of orders received via the ordering system;
execute a first bundling system to generate a first solution, the first solution comprising a first plurality of bundles of the plurality of orders;
in parallel with executing the first bundling system, execute a second bundling system to generate a second solution, the second solution comprising a second plurality of bundles of the plurality of orders;
in parallel with executing the first bundling system and the second bundling system, execute a third bundling system to generate a third solution, the third solution comprising a third plurality of bundles of the plurality of orders;
determine a maximum execution time based on the bundling request; and
after the maximum execution time, select the first solution or the second solution or the third solution.

15. The order processing system of claim 14, wherein selecting the first solution or the second solution or the third solution comprises:
determining that the first bundling system generated the first solution within the maximum execution time;
determining that the second bundling system failed to generate the second solution within the maximum execution time; and
selecting the first solution.

16. The order processing system of claim 14,
wherein the order system comprises a mobile application with an option to select a delivery time; and
wherein the maximum execution time is based at least in part on delivery times of the plurality of orders selected via the mobile application.

17. The order processing system of claim 14, wherein the work management system is configured to receive bundles of orders from the order bundling platform and provide, via a mobile application, the bundles of orders to a plurality of workers.

18. The order processing system of claim 14, wherein a first solver of the first bundling system includes a mixed integer mathematical programming formulation that minimizes order completion time and does not include a variable corresponding to a vehicle.

19. A method for bundling orders using a multi-solver bundling platform, the method comprising:
receiving a bundling request, the bundling request comprising a plurality of orders;
executing a first bundling system, the first bundling system comprising at least first hardware, to generate a first solution, the first solution comprising a first plurality of bundles of the plurality of orders;
in parallel with executing the first bundling system, executing a second bundling system, the second bundling system comprising at least second hardware, to generate a second solution, the second solution comprising a second plurality of bundles of the plurality of orders;
in parallel with executing the first bundling system and the second bundling system, executing a third bundling system, the third bundling system comprising at least third hardware, to generate a third solution, the third solution comprising a third plurality of bundles of the plurality of orders;
determine a maximum execution time derived from the bundling request; and
after the maximum execution time or after receiving each of the first solution and the second solution and the third solution, selecting the first solution or the second solution or the third solution.

20. (canceled)

21. The platform of claim 1, wherein the platform stores previously generated solutions such that the platform can select the previously generated solutions, rather than generating new solutions, if a set of orders is received twice.

22. The platform of claim 1, wherein the bundling request comprises synthetic order data.

23. The platform of claim 1, wherein the bundling request comprises at least one of:
actual time to complete a historical order; and
projected time to complete a pending order.

24. The platform of claim 10, wherein the source node is a location from which an item may be shipped.

25. The platform of claim 10, wherein the destination node is a location to which an item may be delivered.

26. The platform of claim 10, wherein each of the orders further comprises node data.

27. The order processing system of claim 17, wherein the work management system offers the bundles of orders to the workers, and if the bundle of orders is not accepted by any worker, then the work management system offers individual orders of the bundle to the workers.
